(19) United States
(12) Patent Application Publication
(10) Pub. No.: US 2008/0276623 A1
(43) Pub. Date: Nov. 13, 2008

(54) MAGNETIC REFRIGERANT MATERIAL

(76) Inventors: Naushad Ali, Carbondale, IL (US); Mahmud Uz-Zaman Khan, Carbondale, IL (US); Shane Stadler, Carbondale, IL (US)

Correspondence Address: Bryan K. Wheelock, Suite 400, 7700 Bonhomme, St. Louis, MO, 63105, US

(21) Appl. No.: 12/119,485

(22) Filed: May 12, 2008

Related U.S. Application Data
(60) Provisional application No. 60/917,635, filed on May 11, 2007.

(51) Int. Cl. F25B 21/00; H01F 1/153

(52) U.S. Cl. 62/3.1; 252/62.55

(57) ABSTRACT

Specific embodiments of magnetocaloric materials useful in magnetic refrigeration systems, for example, are disclosed. The magnetocaloric materials include nickel-manganese-gallium (NiMnGa) alloys in which substitution is made from some of the manganese. Copper is preferably substituted for at least some of the manganese, but cobalt or a combination of cobalt and copper could also be substituted for at least some of the manganese. In the preferred embodiment, the material comprises a nickel-manganese-copper-gallium of the composition Ni₂Mn₁₋ₓCuₓGa, where x is greater than or equal to about 0.22.

### CROSS-REFERENCE TO RELATED APPLICATIONS

This application claims the benefit of U.S. Patent Application Ser. No. 60/917,635, filed May 11, 2007, the entire disclosure of which is incorporated herein.

### BACKGROUND

This invention generally relates to magnetic refrigerant materials, and more particularly, to magnetic refrigerant materials that exhibit a sufficiently great magnetocaloric effect near or at room temperature, and also relates to a regenerator and a magnetic refrigerator that use these magnetic refrigerant materials.

Conventional refrigeration technology utilizes the adiabatic expansion or the Joules-Thomson effect of a gas. However, gas compression/expansion refrigeration technology has relative low efficiency. Furthermore, many of the refrigerants employed, present health risks (e.g. ammonia), or present environmental hazards (e.g. chlorofluorocarbons (CFCs).

While magnetocaloric effect has been studied for a long time, with the discovery of new magnetic materials with high values of magnetic entropy change, it has become an area of increasing interest due to its energy saving potential in refrigeration processes attributable to its high efficiency compared with conventional gas-based refrigeration processes. Thus, efforts have been made at developing refrigeration systems that take advantage of entropy change accompanied by the magnetic phase transition (also known as “magnetic transformation”) of a solid. In magnetic refrigeration systems, cooling is effected by using a change in temperature resulting from the entropy change of a magnetic material. More specifically, a magnetic material used in this method alternates between a low magnetic entropy state with a high degree of magnetic orientation, which is created by the application of a magnetic field to the magnetic material near its Curie temperature, and a high magnetic entropy state with a low degree of magnetic orientation (e.g., randomly oriented state), which is created by the removal of a magnetic field from the magnetic material. This material property is called the “magnetocaloric effect” and a magnetic refrigerator, uses a material exhibiting the magnetocaloric effect (a “magnetocaloric material”) as its magnetic refrigerant material or regenerative material.

Some examples of magnetocaloric materials include Gd(SiₓGe₁₋ₓ)₄ with a ΔS of about −20 J/Kg·K at 275 K, MnFeP₁₋ₓAsₓ with a ΔS of about −19 J/Kg·K at 276 K; MnAs₁₋ₓ with a ΔS of about −4.1 J/Kg·K; NiMnSn and Ni₂MnGa Heusler alloys with a ΔS of about −20 J/Kg·K at 300-325 K. These and other magnetocaloric materials are disclosed in U.S. Pat. Nos. 6,826,915, 5,743,095, 5,462,610, and 5,435,137, incorporated herein by reference.

### SUMMARY OF THE INVENTION

The present invention relates to magnetocaloric materials useful for example, in magnetic refrigeration systems. Specific embodiments of the material comprise nickel-manganese-gallium (NiMnGa) alloys in which substitution is made from some of the manganese. Copper is preferably substituted for at least some of the manganese, a combination of copper and cobalt could also be substituted for at least some of the manganese, of the formula Ni₂Mn₁₋ₓ(Cu, Co)ₓGa. In the preferred embodiment, the material comprises a nickel-manganese-copper-gallium of the composition Ni₂Mn₁₋ₓCuₓGa, where x is greater than or equal to about 0.22.

The present invention also relates to refrigeration systems employing magnetocaloric materials comprising a substituted nickel-manganese-gallium alloy(NiMnCoCuGa), and preferably, a copper-substituted nickel-manganese-gallium (NiMnCuGa) alloy. In the preferred embodiments, the material comprises a nickel-manganese-copper-gallium of the composition Ni₂Mn₁₋ₓCuₓGa, where x is greater than or equal to about 0.22.

### BRIEF DESCRIPTION OF THE DRAWINGS

FIG. 1 is a M versus T curve as a function of copper concentration;

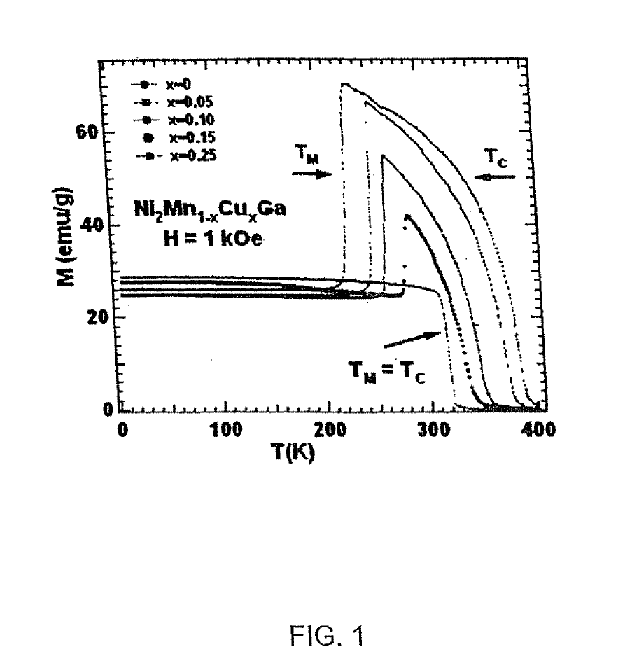

FIG. 2 is a temperature versus concentration phase diagram of copper substitution for manganese, showing the phase transformation temperatures change with increasing x to about 0.22 where there is a single phase transformation temperature;

FIG. 3 is a magnetization versus temperature curve for material of the composition Ni₂Mn_{0.75}Cu_{0.25}Ga, showing the temperature dependence of the magnetization during a cooling and warming cycle in the vicinity of T_{C};

FIG. 4 is a graph of magnetization isotherms.

FIG. 5 is a graph showing the ΔS_{mag} for Ni₂Mn_{0.75}Cu_{0.25}Ga as a function of temperature at different magnetic fields.

FIG. 6 is an illustration of one possible refrigeration system utilizing the magnetocaloric material described herein.

### DETAILED DESCRIPTION

Ni2MnGa undergoes two major transitions as a function of temperature: (1) a second order paramagnetic-ferromagnetic transition at T_{C}=376 K; and (2) a magnetostructural transition from a ferromagnetic austenitic phase to a ferromagnetic martensitic phase T_{M}=202 K. The inventors have discovered that substituting for Mn can change the transition temperatures such that TC decreases as T_{M} increases, so that at some composition the two transition temperatures coincide. For example, in the case of copper substitution for manganese, the inventors have discovered that at copper concentrations of greater than or equal to about 0.22, the transition temperatures coincide.

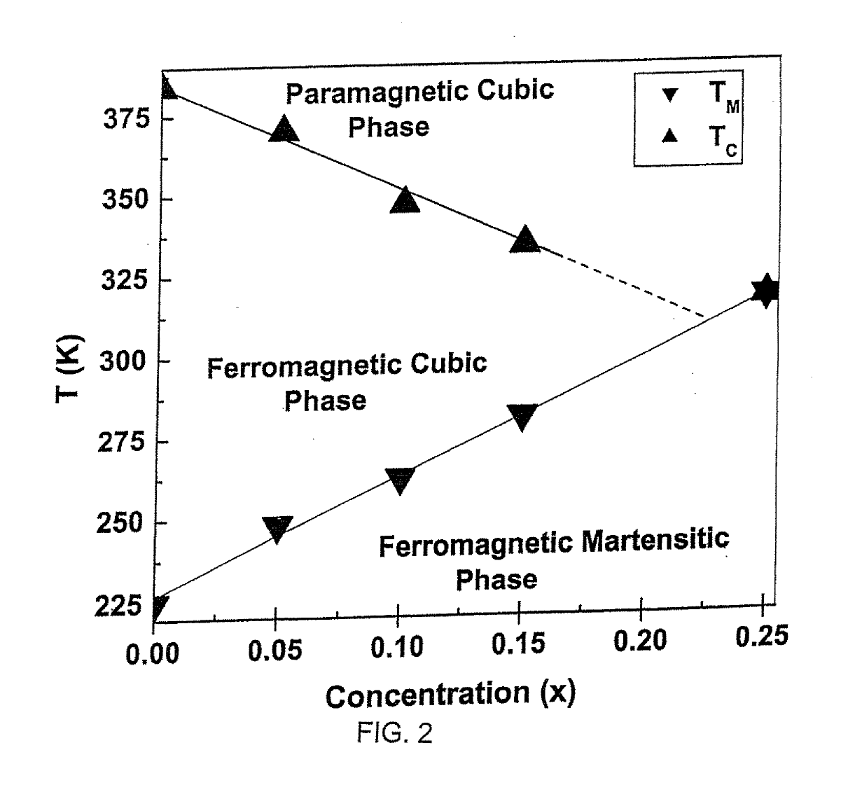

As shown in FIG. 2, the substitute of copper for manganese results in a near linear decrease of T_{C} and increase of T_{M}, and starting at x> about 0.22, only on transition T_{C}=T_{M} can be observed.

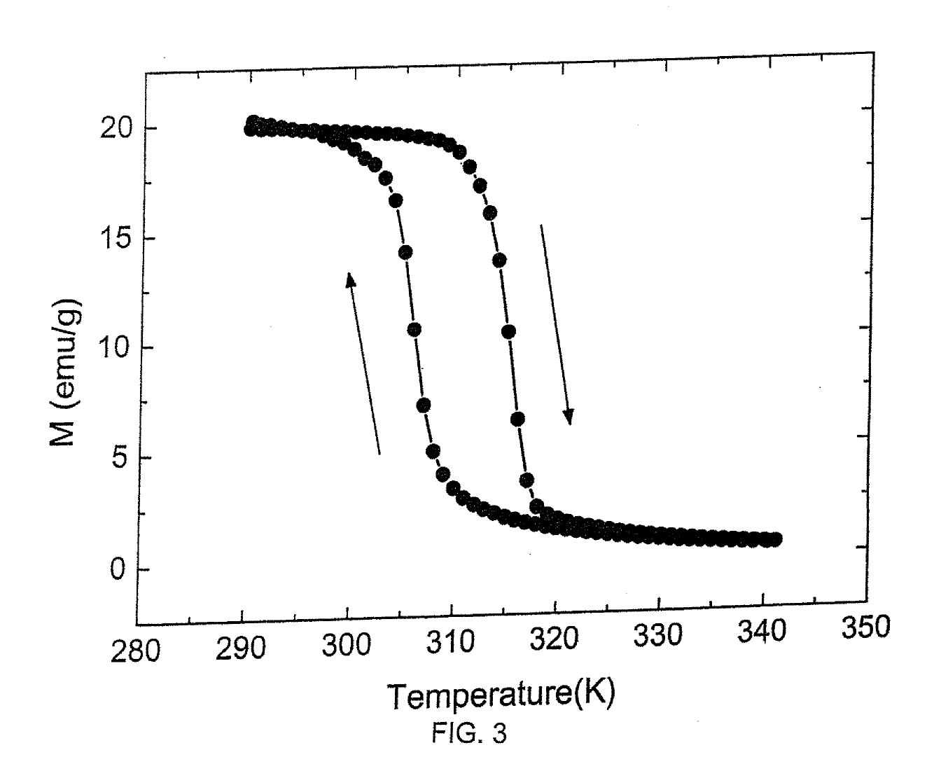

FIG. 3 shows the temperature dependence of the magnetization for Ni₂Mn_{0.75}Cu_{0.25}Ga measured during a cooling and warming cycle in the vicinity of TC. FIG. 3 shows a thermal hysteresis of magnetization, typical for the first order phase transitions. Thus, starting from x=about 0.22, the Ni₂Mn₁₋ₓCuₓGa alloys undergo the first order transition from paramagnetic cubic to ferromagnetic martensitic phase above room temperature.

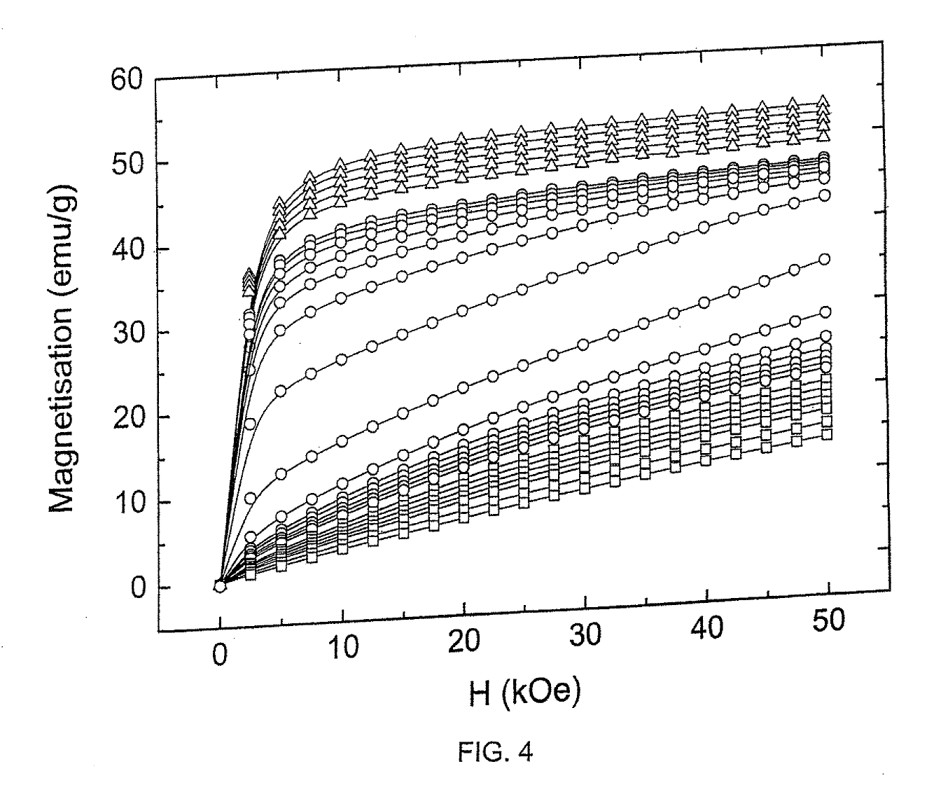

FIG. 4 shows magnetization isotherms M(H) obtained in warming run. Below the Curie temperature the M(H) curves are almost saturated, reaching 53.3 emu/g at the highest field (50 kOe). The measurements shown in FIG. 4 were used to calculate the magnetic entropy change driven by field and temperature variation using a numerical approximation for the relationship:

$$Δ {S}_{mag} ( T , H ) = {\int }_{O}^{H} {( \frac{\partial M}{\partial T} )}_{H} d H$$

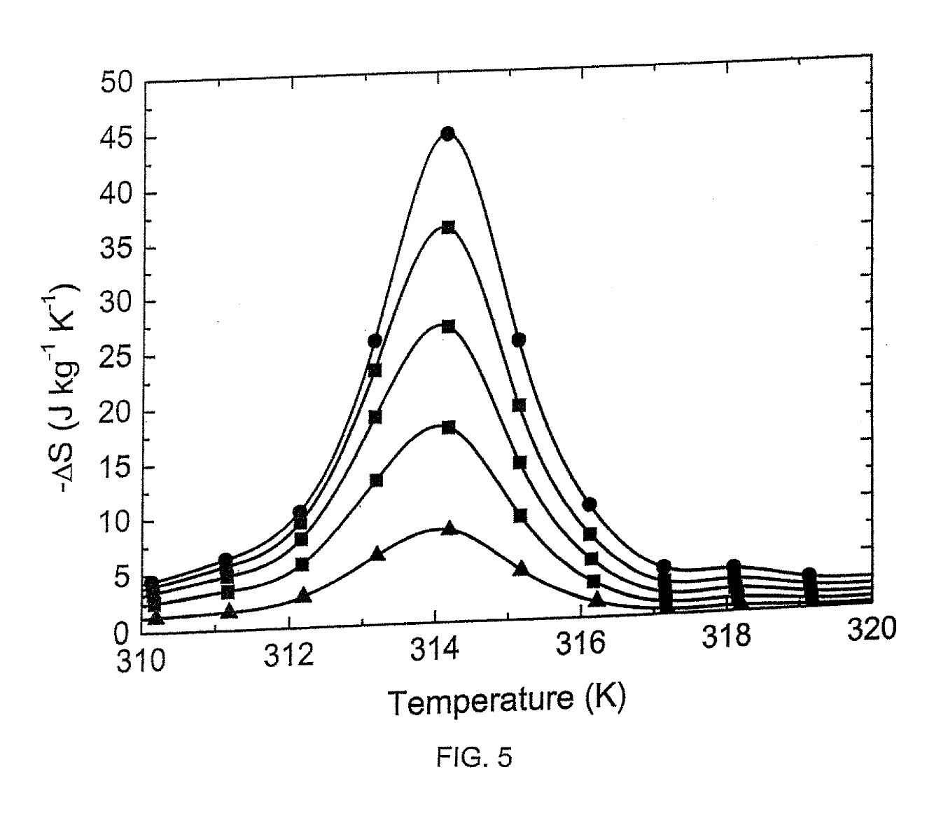

FIG. 5 shows the values of ΔS_{mag} for Ni₂Mn_{0.75}Cu_{0.25} Ga as a function of temperature at different magnetic fields. The maximum value is −45 J K⁻¹ k⁻¹ at 314.1 K for ΔH=50 kOe. The magnetic entropy change is directly proportional to the applied magnetic field with a proportionality constant=0.91 J K⁻¹ kg⁻¹ kOe⁻¹. These values are the highest reported to date above room temperature. From the magnetic phase diagram, it is expected that the samples with Cu concentration around 25% (see FIG. 2) can be useful to obtain the high MCE at lower/higher temperatures.

Thus, the high magnetic entropy variation observed in Cu doped Ni₂MnGa based Heusler alloys appears to arise from the coexistence of first-order structural (martensitic) and magnetic order transitions at T_{c}.

For temperatures around 315 K we measured the curves with smaller temperature steps, in order to obtain a better definition of the magnetization change around the Curie temperature.

The inventors have discovered that at this microstructural composition, a giant magnetocaloric effect occurs. The magnitude of the entropy change ΔS (or MCE) is larger than that of other magnetocaloric materials presently under consideration for use in near-room temperature refrigeration systems. The largest value of ΔS previously known to the inventors was −18 J/Kg·K at a field value of 5 Tesla (T), for the intermetallic compound Gd₅Si₂Ge₂. Similar values of ΔS have been measured for MnFeP₁₋ₓAsₓ. In comparison, the measured value of ΔS for Ni₂Mn_{0.75}Cu_{0.25}Ga is about −45 J/Kg·K, which is more than two times the highest value previously known to the inventors.

The properties of Ni₂Mn₁₋ₓCuₓGa are ideally suited for magnetic refrigeration applications. First, suitable magnetocaloric materials must have a significant ΔS (or MCE) at reasonable magnetic field values, and Ni₂Mn₁₋ₓCuₓGa has the highest ΔS known to the inventors. Furthermore, the ΔS of Ni₂Mn₁₋ₓCuₓGa at 2 T is about −20 J/Kg·K, which is greater than other materials at 5 T. Fields of 2 T can be easily produced by permanent magnets or electromagnets. Second, the phase transition responsible for the magnetocaloric effect must be reversible by changing/reversing the applied magnetic field, and that is the case for Ni₂Mn₁₋ₓCuₓGa. Magnetization data shows that the transition in Ni₂Mn₁₋ₓCuₓGa is reversible. Hysteresis losses for the material should be minimal, which is the case for Ni₂Mn₁₋ₓCuₓGa. Magnetization curves for Ni₂Mn₁₋ₓCuₓGa show no discernable hysteresis. Finally, the transition responsible for the magnetocaloric effect, should occur at a usable temperature range (i.e. at or near room temperature), which is the case for Ni₂Mn₁₋ₓCuₓGa.

In addition, the material is preferably environmentally friendly, non-toxic, and affordable, which is the case for Ni₂Mn₁₋ₓCuₓGa. Of the other magnetocaloric materials, gadolinium-based materials such as Gd₅Si₂Ge₂ and rare-earth based materials generally are relatively expensive. MnFeP₁₋ₓAsₓ based materials include arsenic, which can be environmentally undesirable.

The present results surpass the known best magnetocaloric materials at high temperatures, with the highest value or magnetic entropy change. The Cu-doped NiMnGa Heusler alloys maybe a preferred alternative to the expensive Gd based magnetic refrigerants materials, as well as, to the potentially toxic MnAs compounds. These features are of great interest for magnetic refrigeration.

The present magnetocaloric materials at room temperature are key for the new environmentally friendly and highly efficient refrigeration technology, and the discovery of high MCE in the Ni₂Mn_{0.75}Cu_{0.25}Ga Heusler material opens new horizons for applications in magnetic refrigeration technology.

For the current study, we used a polycrystalline sample fabricated by conventional arc-melting methods and characterized by X-ray diffraction and magnetometry measurements. The magnetization measurements were performed by SQUID and extraction magnetometers in the temperature interval 4-400 K and at magnetic fields up to 5 T. The magnetocaloric properties were calculated from isothermal magnetization data, M(H), using a sample of (151.9+/−0.1) mg.

The magnetocaloric materials of the various embodiments described herein are suitable for refrigeration systems, including heat pumps, refrigerators, air conditioners, freezers, and liquifiers.

A regenerator according to a preferred embodiment of the present invention, preferably includes first and second regenerative beds, each including the magnetic refrigerant material in accordance with this disclosure, and a mechanism for applying mutually different magnetic fields to the first and second regenerative beds.

In one preferred embodiment of the present invention, each of the first and second regenerative beds may include a plurality of magnetic refrigerant materials that exhibit the magnetic phase transition at respectively different temperatures. Specifically, the magnetic refrigerant materials may form multiple layers that are stacked one upon another.

In another preferred embodiment of the present invention, each of the first and second regenerative beds may include the magnetic refrigerant material and a binder.

In still another preferred embodiment, the mechanism for applying the magnetic fields may include a magnetic circuit including a permanent magnet. The magnetic circuit may variably control the strengths of the magnetic fields to be applied to the first and second regenerative beds. Alternatively, the regenerator may further include a mechanism for shuttling the first and second regenerative beds back and forth between a first position, which is inside the magnetic field created by the permanent magnet, and a second position, which is outside of the magnetic field, thereby applying the mutually different magnetic fields to the first and second regenerative beds.

A magnetic refrigerator according to still another preferred embodiment of the present invention preferably includes a regenerator, such as described above, and a cold-side heat exchanger and a hot-side heat exchanger that are thermally coupled to the regenerator.

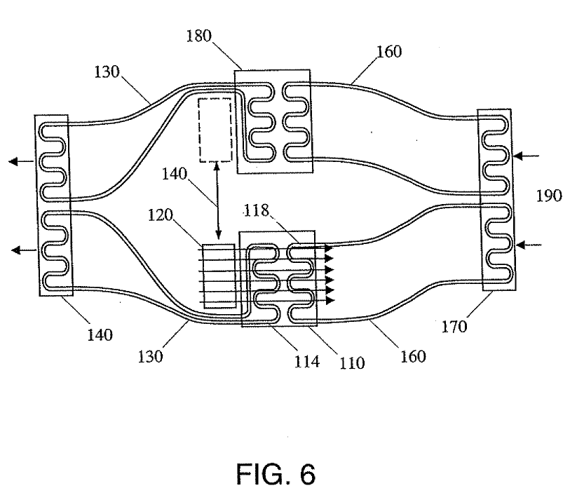

Referring to FIG. 6, a refrigeration system analogous to a Carnot cycle or Vapor-Compression cycle is shown. The magnetocaloric or magnetic refrigerant materials disclosed in the present application is received in a first regenerative bed 110 in an insulated environment, where a magnetic field generator source 120 applies a magnetic field, such as a 0.4 to 0.6 Tesla field, for example. The magnetization of the magnetocaloric material causes the magnetic dipoles of the material to align, and causes the magnetocaloric material to heat up as it transitions from the paramagnetic martensitic phase to the ferromagnetic austenitic state in an adiabatic process. The magnetization causes the magnetocaloric material to undergo an increase in temperature due to the magnetocaloric effect. This phase is analogous to the compression stage of a Carnot or Vapor-Compression cycle. The magnetization of the magnetocaloric material may be accomplished by application of electrical current to an electromagnet, or alternatively by a permanent magnet source that is positioned relative to the first regenerative bed by an actuator that either moves the permanent magnet or the first regenerative bed relative to the other. In yet another alternate construction, the magnetocaloric material may alternatively be introduced into the first regenerative bed being subjected to a magnetic field by means of a pump, which pumps the magnetocaloric material into the regenerative bed from a location away from the magnetic field.

While the heated magnetocaloric material is still exposed to a magnetic field, the magnetocaloric material is then subjected or exposed to a cooling medium in communication with the regenerative bed via communication lines 130. The cooling medium may be a liquid, such as water that is pumped through a heat exchanger 114 in the first regenerative bed 110, such that heat from the magnetocaloric material is transferred to and absorbed by the cooling water to thereby cool the magnetocaloric material. Alternatively, other absorbent materials such as lithium bromide may be used in place of water. Likewise, gaseous materials may also be employed as a cooling medium through a heat exchanger within the first regenerative bed. The heat absorbed by the cooling medium is then conducted or dissipated through a heat exchanger 140 to an ambient surrounding or heat sink. This phase is analogous to the condenser stage of a Vapor-Compression cycle.

Next, the magnetocaloric material is then thermally insulated in an adiabatic process in which the magnetic field is removed or diminished. The magnetocaloric material in the first regenerative bed would ideally be separated or insulated from the heat exchanger, or any thermal transfer medium within the heat exchanger, so as to prevent or minimize heat transfer from the magnetocaloric material to a thermal medium. The removal or diminishing of the magnetic field, or demagnetization of the magnetocaloric material causes the magnetocaloric material to return to their previous domains or disorder of dipoles, during which thermal energy is absorbed and transferred to magnetic energy. This thermal energy transfer results in a significant drop in temperature in the magnetocaloric material, as the material returns to a paramagnetic state. This phase is analogous to the expansion stage of a Vapor-Compression cycle. It should be noted that the magnetic field may be diminished or removed by discontinuing the application of current in an electromagnet, or by use of an actuator (depicted by arrow 150) for moving a permanent magnet source away from the first regenerative bed, where a permanent magnet is employed. Alternatively, the first regenerative bed having the magnetocaloric material may be moved by an actuator away from the magnetic field generated by a permanent magnet or electromagnet, rather than utilizing an actuator for moving the magnet source. In yet another alternate construction, the magnetocaloric material within the first regenerative bed exposed to a magnetic field (by a permanent magnet source, for example), may be removed from the first regenerative bed by a pump to a location away from the magnetic field, such as to a heat exchanger in an environment that the refrigeration system is intended to cool or refrigerate, for example.

Lastly, the demagnetized magnetocaloric material is maintained at the diminished magnetic field or demagnetized state, and subjected or exposed to a thermal transfer medium in communication with the regenerative bed via heat exchanger 118. The thermal transfer medium may be a liquid, such as water, that is pumped through a heat exchanger 118 in the first regenerative bed 110, such that heat from the relatively warmer water is transferred to and absorbed by the cooled magnetocaloric material to thereby lower the temperature of the thermal transfer medium. In the system shown in FIG. 4, the absorbing liquid is then pumped via communication lines 160 to a heat exchanger 170 at a location 190 that is intended to be refrigerated. Alternatively, the thermal transfer medium may be the air within an environment 190 that the refrigeration system is intended to cool or refrigerate, where thermal transfer occurs directly between the environment 190 and the regenerative bed. Other absorbent materials, such as lithium bromide, may be used in place of water. Likewise, gaseous materials may also be employed as a thermally absorbing medium. This phase is analogous to the evaporator stage of a Vapor-Compression cycle.

The refrigeration system may comprise a second regenerative bed 180, where the first and second regenerative beds are alternately subjected to magnetization such that one bed experiences a transition to a high temperature, while the other bed experiences a transition to a cool temperature. In this arrangement, cooling medium is selectively communicated via lines 160 between the environment to be cooled and the regenerative bed that is exposed to a magnetic field for causing the magnetocaloric material to increase in temperature. Likewise, the regenerative bed that is demagnetized is in communication with a heat exchanging means for the environment intended to be refrigerated. In this manner, the first and second beds may be alternated relative to a magnetic field source, to provide for selectively magnetizing and demagnetizing the regenerative beds, such that each bed may alternate to provide continuous refrigeration of an environment. It should be noted that the only expenditure of energy in the system involves the actuator for moving the magnet (or for alternatively moving the regenerative beds relative to the magnet), and pumps for circulating thermal transfer medium.

What is claimed is:

1. A magnetocaloric material of the composition Ni₂Mn₁₋ₓAₓGa, where A is copper or a combination of copper and cobalt, and x≧0.22.

2. The magnetocaloric material of claim 1 wherein A is copper

3. The magnetocaloric material of claim 2 wherein x=0.25 A

4. A magnetic refrigeration system in which the magnetic refrigerant comprises Ni₂Mn₁₋ₓAₓGa, where A is copper or a combination of copper and cobalt, and x≧0.22

5. The magnetic refrigeration system of claim 4 wherein A is copper.

6. The magnetic refrigeration system of claim 5 wherein x=0.25 A.

7. A magnetic regeneration system in which the magnetic refrigerant comprises Ni₂Mn₁₋ₓAₓGa, where A is copper or a combination of copper and cobalt, and x≧0.22.

8. The magnetic regeneration system of claim 7 wherein A is copper.

9. The magnetic generation system of claim 8 wherein x=0.25 A.

10. A magnetic heat pump system in which the magnetic refrigerant comprises Ni₂Mn₁₋ₓAₓGa, where A is copper or a combination of copper and cobalt, and x≧0.22

11. The magnetic heat pump system of claim 10 wherein A is copper.

12. The magnetic heat pump system of claim 11 wherein x=0.25 A.

13. A magnetic air conditioning system in which the magnetic refrigerant comprises Ni₂Mn₁₋ₓAₓGa, where A is copper or a combination of copper and cobalt, and x≧0.22.

14. The magnetic air conditioning system of claim 13 wherein A is copper.

15. The magnetic air conditioning system of claim 14 wherein x=0.25 A.

16. A magnetic freezer system in which the magnetic refrigerant comprises Ni₂Mn₁₋ₓAₓGa, where A is copper or a combination of copper and cobalt, and x≧0.22.

17. The magnetic freezer system of claim 16 wherein A is copper.

18. The magnetic freezer system of claim 17 wherein x=0.25 A.

19. A magnetic liquification system in which the magnetic refrigerant comprises Ni₂Mn₁ AₓGa, where A is copper or a combination of copper and cobalt, and x≧0.22

20. The magnetic liquification system of claim 19 wherein A is copper.

21. The magnetic liquification system of claim 20 wherein x=0.25 A.
